(19) United States
(12) Patent Application Publication
(10) Pub. No.: US 2016/0359931 A1
(43) Pub. Date: Dec. 8, 2016

(54) METHOD AND APPARATUS FOR DOWNLOADING AN APPLICATION

(71) Applicant: Yandex Europe AG, Luzern (CH)

(72) Inventors: Yaroslav Nikolaevich GONCHAROV, Sosnoviy Bor, Leningrad region (RU); Konstantin Pavlovitch GORSKIY, Moscow (RU); Tigran Oganesovich KHUDAVERDYAN, Moscow (RU)

(21) Appl. No.: 15/118,925

(22) PCT Filed: Aug. 21, 2015
(86) PCT No.: PCT/IB2015/056342

§ 371 Date: Aug. 15, 2016

(30) Foreign Application Priority Data
Feb. 4, 2015 (RU) 2015103671

(51) Int. Cl. H04L 29/06; G06Q 20/12; H04W 4/00

(52) U.S. Cl. CPC H04L 65/4023; H04W 4/003; G06Q 20/123

(57) ABSTRACT

There is disclosed a method of downloading an application to an electronic device associated with a user. The method is executed at a server, the server being connectable to the electronic device via a communication network. The method comprises: receiving from the electronic device, via the communication network, an indication of the application to be downloaded to the electronic device; based on the indication, determining a first application and a second application potentially associated with the indication of the application, the first application and the second application not having been installed on the electronic device; transmitting both the first application and the second application to the electronic device.

### CROSS-REFERENCE

The present application claims priority to Russian Patent Application No. 2015103671, filed Feb. 4, 2015, entitled “METHOD AND APPARATUS FOR DOWNLOADING AN APPLICATION” the entirety of which is incorporated herein.

### TECHNICAL FIELD

The present technology relates to methods and apparatuses for downloading an application, and more specifically to a method and an apparatus for downloading an application from an application repository.

### BACKGROUND

There are hundreds of thousands of software applications available to be installed on electronic devices such as smartphones, tablet computers, and other digital electronic devices, and many more are released every day. A user of a typical electronic device has access to a number of applications. When such an electronic device is first purchased (or otherwise obtained by the user), it typically includes a somewhat small set of preinstalled applications having been selected by the manufacturer and/or the retailer of the device and pre-installed onto the electronic device before it is put into the stream of commerce.

If the user of the device wants to use any additional applications not included among the preinstalled applications, the user is expected to acquire and install each additional application on her or him own.

Methods of installing these applications have evolved significantly in recent years. In the past, applications were typically distributed on a computer-readable removable storage medium such as a diskette or a CD-ROM and installed on the device via a disk drive. As high-speed Internet connections have become more widespread, applications have increasingly come to be installed by downloading them from a web server and executing an installation routine on the electronic device. On some newer device platforms, users may now purchase and install applications from online repositories such as APPLE'S APP STORE, GOOGLE PLAY, and YANDEX.STORE.

When the user accesses a typical online repository, such as let's say APPLE'S APP STORE, the user is presented with a plethora of choices for applications to download and install. Providers of existing online repositories have attempted to simplify the user experience when browsing the available application to download. For example, the APPLE'S APP STORE has a search feature, which enables the user to search for application. However, the search feature is only partially helpful, as the user needs to know the name of the application that she wishes to download to search for the application.

The APPLE'S APP STORE also offers a top chart feature, which provides a list of applications that are either popular by the number of downloads or by “revenue”. The APPLE'S APP STORE also offers a featured application function, which provides a list of suggested application. Typically, the features applications are broken down into several categories, such as “best new app”, “best new game”, “locally developed” and the like.

WO patent publication 2014\021878 discloses a computing device includes at least one processor to execute a web browser application and a separate and distinct plug-in deployment application. The web browser application receives user action information indicating user interaction with a web page displayed by the web browser application, determines that a new plug-in is to be installed based on the user action information, and provides the plug-in deployment application with download instructions for downloading the new plug-in. The plug-in deployment application automatically downloads the new plug-in in response to the download instructions without user involvement, and automatically installs the new plug-in on the computing device without user involvement.

U.S. Pat. No. 8,539,038 teaches a method and system for preloading data. Resources are preloaded on a client device before they are needed by an application. Application hints and static resources lists may be used to indicate resources are needed. The application may begin execution before receiving all of the resources associated with the application. Preloading may be done during execution of an application, or when the application is not executing. Preloading allows an application to run smoothly without consuming more resources than are needed by an application. A prediction graph may be generated that is used in predicting the resources that are likely to be needed by the application. An analyzer may also be used to simulate the system and adjust parameters used in creating the prediction graph.

### SUMMARY

It is an object of the present technology to ameliorate at least some of the inconveniences present in the prior art.

Developers have appreciated that there exists at least one technical problem associated with the current state of the art approaches to organization of the on-line application repositories and execution of the downloading of the new apps to the user's electronic device.

As has been outlined above, when the user wishes to install an application onto her or him electronic device, the user needs to access the on-line repository of applications and to select the application he or she desires to download and to install onto the electronic device. In order to select the application, the user has to navigate and to choose among thousands of applications potentially available to him or her (whether by using search feature, navigating one or more categories and the like). Once the user has selected the application, the user needs to initiate the application download process, which can be relatively long and cumbersome for some users.

As the user goes through the application selection and downloading process, several control messages and data are exchanged between the user's electronic device and the on-line repository of applications. More specifically, when the user starts the depository application on the electronic device, the electronic device transmits a search request to the depository server (such as the name of the application, or application type, such as music app, a game, an office app etc., a category type or the like). In response to the search request, the repository server sends data representative of available applications that are responsive to the user search request to the electronic device. If the user is not able to locate the application of interest, the process is repeated until the user locates the application of interest to him or her. Once the user locates the application of interest, the user confirms her or him choice of the application, the electronic device sends an application download request to the repository server and the repository server transmits to the electronic device the application installation file, which can be then installed on the electronic device (in most instances after the user having to confirm certain parameters, such as password for access and payment with the application download service).

All these messages exchanged between the electronic device and the repository server (which can be numerous in case of the user keeps browsing the hundreds of applications presented to him or her in the attempt to locate the one application of interest) put a significant strain on the bandwidth of the communication network between the electronic device and the repository server. In those cases where the electronic device connects to the repository server via a wireless communication network (where the user may have to pay per volume of data usage), this may put a significant financial strain on the user, in addition to unnecessary using the available bandwidth of the network.

According to a first broad aspect of the present technology, there is provided a method of downloading an application to an electronic device associated with a user. The method is executed at a server, the server being connectable to the electronic device via a communication network. The method comprises: receiving from the electronic device, via the communication network, an indication of the application to be downloaded to the electronic device; based on the indication, determining a first application and a second application potentially associated with the indication of the application, the first application and the second application not having been installed on the electronic device; transmitting both the first application and the second application to the electronic device.

In some implementations of the method, the transmitting is executed without receiving an express user confirmation of the user desire to have the transmitting executed.

In some implementations of the method, the method further comprises receiving an indication of plurality of user events.

In some implementations of the method, the determining is based at least in part on the indication of plurality of user events.

In some implementations of the method, the step of determining further comprises determining a third application potentially associated with the indication of the application, and wherein the method further comprises, prior to the transmitting: selecting the first application and the second application from the first application, the second application and the third application to be transmitted to the electronic device, the step of selecting being based at least in part on the indication of plurality of user events.

In some implementations of the method, the method further comprises receiving an indication of at least one parameter of the electronic device and wherein the step of selecting is further based at least in part on the at least one parameter of the electronic device.

In some implementations of the method, the indication of plurality of user events comprises at least one of:
a list of applications previously downloaded by the user;
a list of applications currently installed on the electronic device;
a list of applications previously downloaded and later deleted by the user.

In some implementations of the method, the method further comprises receiving, from the electronic device, a first usage indicator associated with the first application and a second usage indicator associated with the second application, the respective first usage indicator and the second usage indicator having been generated by the electronic device by monitoring if the user has interacted with the respective first application and the second application.

In some implementations of the method, the monitoring is executed within a pre-determined period of time from the transmitting.

In some implementations of the method, responsive to one of the first usage indicator and the second usage indicator being indicative of non-interaction with the respective one of the first application and the second application, the method further comprises: transmitting to the electronic device a deletion trigger, the deletion trigger for causing the electronic device to delete the respective one of the first application and the second application.

In some implementations of the method, a respective one of the first usage indicator associated with the first application and the second usage indicator associated with the second application has been generated in response to the user first launching the respective one of the first application and the second application.

In some implementations of the method, a respective one of the first usage indicator associated with the first application and the second usage indicator associated with the second application has been generated in response to the user: first launching the at least one of the first application and the second application using the electronic device; confirming payment information.

In some implementations of the method, a respective one of the first usage indicator associated with the first application and the second usage indicator associated with the second application has been generated in response to the user: first launching the at least one of the first application and the second application using the electronic device; confirming feature selection information.

In some implementations of the method, the transmitting both the first application and the second application to the electronic device comprises transmitting a first execution file associated with the first application and a second execution file associated with the second application, the first execution file configured to cause the electronic device to install the first application and the second execution file configured to cause the electronic device to install the second application.

In some implementations of the method, the first execution file and the second execution file can cause the respective installation of the first application and the second application without receiving an express confirmation from the user.

In some implementations of the method, the indication of the application to be downloaded to the electronic device comprises a portion of a title of the application entered by the user into the electronic device.

In some implementations of the method, the portion of the title has been entered using a search bar.

In some implementations of the method, the search bar is a multi-functional search bar.

In some implementations of the method, the determining a first application and a second application further comprises receiving an indication of at least the first application and the second application from an application repository, the receiving being executed in response to: transmitting the indication of the application to be downloaded to the electronic device to the application repository; generating, by the application repository, the indication of the first application and the second application based on a respective title of the first application and the second application matching the indication of the application to be downloaded to the electronic device.

In some implementations of the method, the determining a first application and a second application further comprises receiving an indication of at least a portion of the first application and the second application from a resource other than the application repository, the resource being accessible via the communication network, the receiving being executed in response to: performing a general web search and locating the resource other than the application repository that hosts at least the portion of the first application and the second application.

In some implementations of the method, the method further comprises receiving a payment instruction associated with at least one of the first application and the second application from the electronic device, the payment instruction having been generated by the electronic device in response to the user: first launching the at least one of the first application and the second application using the electronic device; confirming payment information.

In some implementations of the method, the electronic device is a tablet device.

According to another broad aspect of the present technology, there is provided a server. The server comprises: a communication interface for a two-way communication with a an electronic device over a communication network, a processor coupled to the communication interface, the processor configured to: receive from the electronic device, via the communication network, an indication of the application to be downloaded to the electronic device; based on the indication, determine a first application and a second application potentially associated with the indication of the application, the first application and the second application not having been installed on the electronic device; transmit both the first application and the second application to the electronic device.

According to yet another broad aspect of the present technology, there is provided a method of downloading an application to an electronic device associated with a user. The method is executed at a server. The server is connectable to the electronic device via a communication network. The method comprises: receiving from the electronic device, via the communication network, an indication of the application to be downloaded to the electronic device; based on the indication, determining a first application potentially associated with the indication of the application, the first application not having been installed on the electronic device; transmitting the first application to the electronic device, the transmitting being executed without receiving an express user confirmation of the user desire to have the transmitting executed.

In the context of the present specification, unless expressly provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless expressly provided otherwise, “client device” is any computer hardware that is capable of running software appropriate to the relevant task at hand. Thus, some (non-limiting) examples of client devices include personal computers (desktops, laptops, netbooks, etc.), smartphones, and tablets. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, unless expressly provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the expression “component” is meant to include software (appropriate to a particular hardware context) that is both necessary and sufficient to achieve the specific function(s) being referenced.

In the context of the present specification, unless expressly provided otherwise, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, the expression “interactive” is meant to indicate that something is responsive to a user's input or that at least portions thereof are responsive to a user's input.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a front view of an electronic device implemented in accordance with some non-limiting embodiments of the present technology.

FIG. 2 is a back view of the electronic device of FIG. 1.

FIG. 3 is a side view of the electronic device of FIG. 1.

FIG. 4 depicts a schematic diagram of the electronic device of FIG. 1.

FIG. 5 depicts a schematic diagram of a system suitable for implementing non-limiting embodiments of the present technology, the system including the electronic device of FIG. 1.

FIG. 6 depicts a schematic representation of information maintained by an application storage of the system of FIG. 5, the application storage being implemented in accordance with non-limiting embodiments of the present technology.

FIG. 7 depicts a schematic representation of information maintained by a log database of the system of FIG. 5, the log database being implemented in accordance with non-limiting embodiments of the present technology.

FIG. 8 depicts a screen shot depicting an output of a first application, the first application being executed on the electronic device of FIG. 1 and displayed on an input output module of the electronic device.

FIG. 9 depicts a screen shot depicting an output of a second application, the second application being executed on the electronic device of FIG. 1 and displayed on the input output module of the electronic device.

FIG. 10 depicts a flow chart of a method executed by a server of the system of FIG. 5, the method being implemented in accordance with non-limiting embodiments of the present technology.

### DETAILED DESCRIPTION

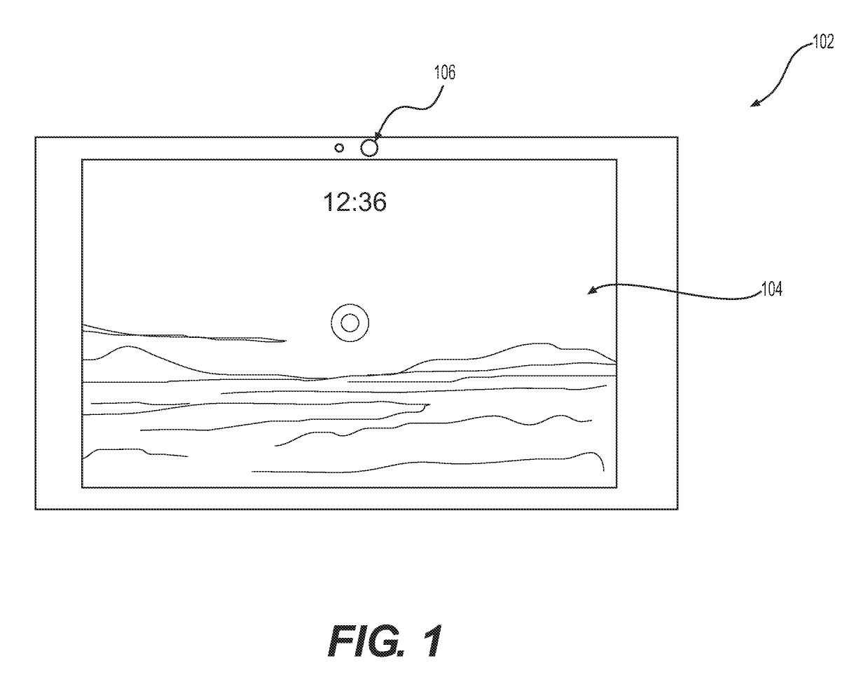

With reference to FIG. 1, there is depicted a front view of the electronic device 102, the electronic device 102 being implemented in accordance with the non-limiting embodiments of the present technology. Within the illustration of FIG. 1, the electronic device 102 is executed as a tablet electronic device and, as such, can be referred to herein below as a tablet device 102. However, it should be expressly understood that the teachings of embodiments of the present technology are not limited to the electronic devices 102 being implemented as tablets. As such, teachings presented herein can be adapted by those of ordinary skill in the art to other type of wireless electronic devices (a cell phone, a smartphone, a personal digital assistant and the like), as well as a personal computer (desktops, laptops, netbooks, etc.), or even network equipment (a router, a switch, or a gateway).

In the depicted illustration of FIG. 1, the tablet device 102 can be an ANDROID based tablet device in the sense that the tablet device 102 operates on the ANDROID based mobile operating system (OS), which in turn can be based on a Linux kernel and currently being promulgated by Google Corporation of Googleplex, Mountain View, Calif., United States of America. However, in alternative non-limiting embodiments, the tablet device 102 can operate on a different type of an operating system, such as (but not limited to): WINDOWS operating system, iOS, MAC OS and the like.

The general construction of the tablet device 102 is well known to those of skill in the art and, as such, only a high level description thereof will be presented here.

Within the depicted illustration, the tablet device 102 comprises an input output module 104. Input output module 104 may comprise one or more input and output devices. For example, input output module 104 may include keyboard, mouse, one or more buttons, thumb wheel, and/or display (e.g., liquid crystal display (LCD), light emitting diode (LED), Interferometric modulator display (IMOD), or any other suitable display technology).

Generally, the input portion of the input output module 104 is configured to transfer data, commands and responses from the outside world into the tablet device 102. The output portion of the input output module 104 is generally configured to display a graphical user interface (GUI) that provides an easy to use visual interface between a user of the tablet device 102 and the operating system or application(s) running on the tablet device 102. Generally, the GUI presents programs, files and operational options with graphical images. During operation, the user may select and activate various graphical images displayed on the display in order to initiate functions and tasks associated therewith.

In the depicted embodiment, the input output module 104 is implemented as a touch screen, which implements functionality of both an input device (by means of acquiring user's touch based commands) and an output device (i.e. a screen). In other words, the touch screen is a display that detects the presence and location of user touch-based inputs. In alternative embodiments, the input output module 104 can be implemented as a separate screen and a separate input device. In yet alternative embodiments, the input output module 104 can include a physical keyboard (including one or more physical buttons) in addition to the touchscreen.

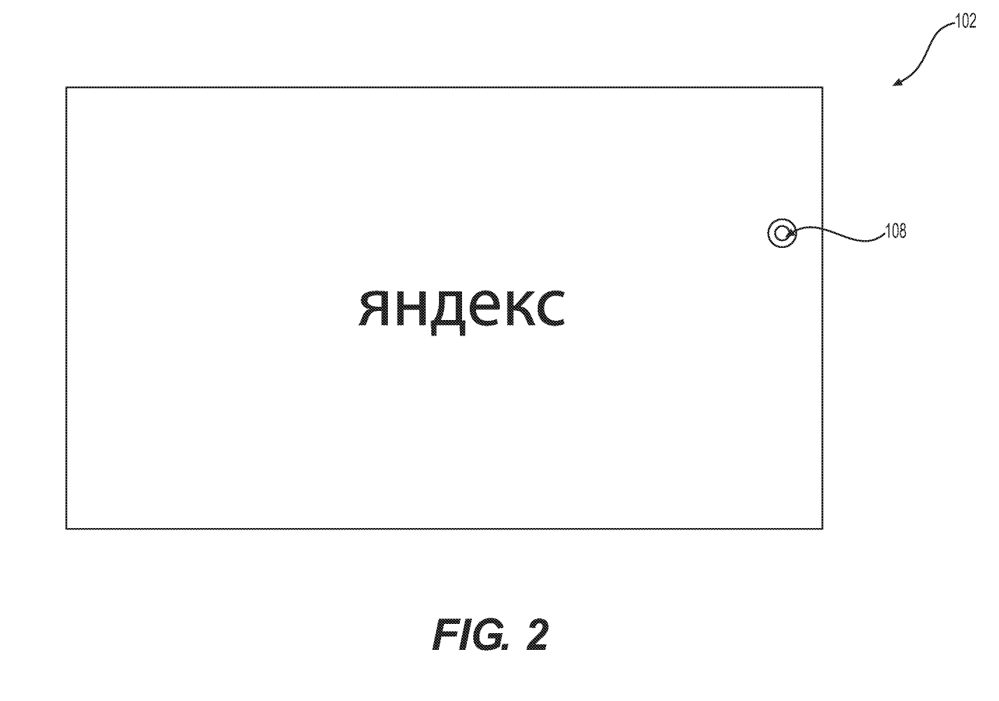

With additional reference to FIG. 2, which depicts the back view of the tablet device 102, the tablet device comprises a front camera 106 and a back camera 108, together referred to as cameras 106, 108. For example, the cameras 106, 108 can include an optical sensor (e.g., a charged coupled device (CCD), or a complementary metal-oxide semiconductor (CMOS) image sensor), to facilitate camera functions, such as recording photographs and video clips.

Even though in the depicted embodiment, both the front camera 106 and the back camera 108 are present, in alternative embodiments only a single instance thereof can be implemented. By the same token, one or both of the front camera 106 and the back camera 108 can include multiples thereof. Finally, the exact placement of the front camera 106 and the back camera 108 is not limited to those placements depicted in FIG. 1 and FIG. 2.

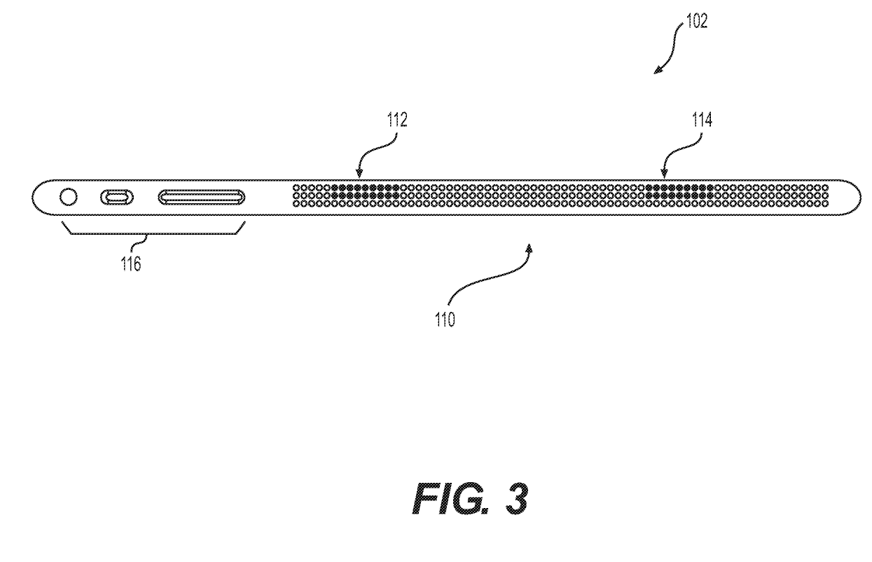

With reference to FIG. 3, which depicts a side view of the tablet device 102, the tablet device 102 further includes an audio module 110. In the depicted embodiment, the audio module 110 comprises two sets of speakers—a first speaker 112 and a second speaker 114.

The tablet device 102 can include a set of additional ports, generally depicted at 116. The set of additional ports 116 can have one or more of:
Audio out port (such as 3.5 mm audio out port)
Micro USB port
Mini-HDMI video output
Micro SD card slot
Etc.

It should be noted that the exact number, placement or mix of the ports within the set of additional ports is not limited to those depicted in FIG. 3.

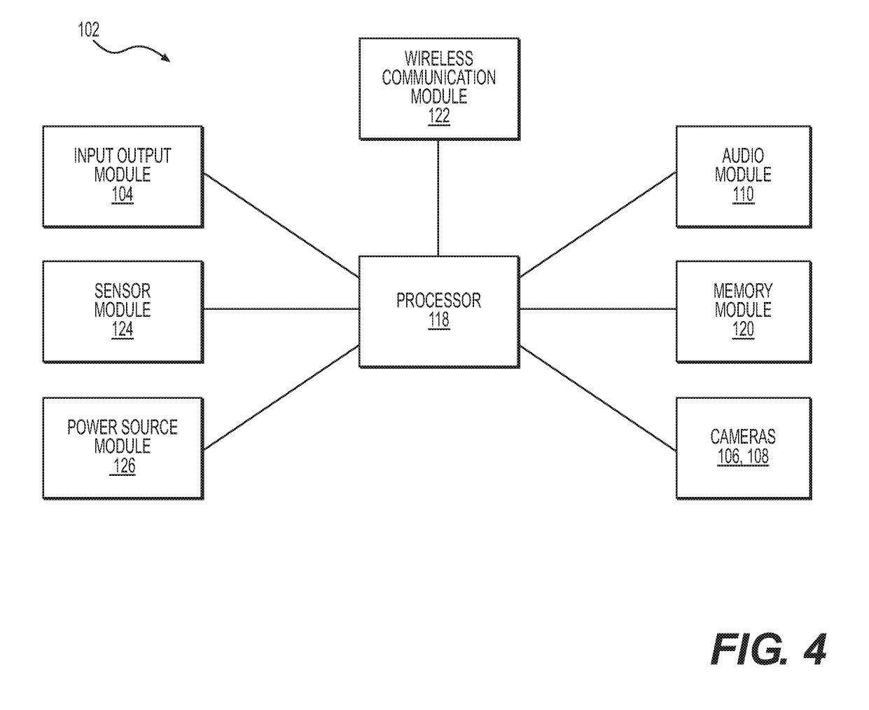

With reference to FIG. 4, there is depicted a schematic diagram of the tablet device 102, which will be used to describe additional details of the general construction and structure of the tablet device 102.

The tablet device 102 may comprise a processor 118. In a particular embodiment, the processor 118 may comprise one or more processors and/or one or more microcontrollers configured to execute instructions and to carry out operations associated with the operation of the tablet device 102. In various embodiments, processor 118 may be implemented as a single-chip, multiple chips and/or other electrical components including one or more integrated circuits and printed circuit boards. Processor 118 may optionally contain a cache memory unit (not depicted) for temporary local storage of instructions, data, or computer addresses. By way of example, the processor 118 may include one or more processors or one or more controllers dedicated for certain processing tasks of the tablet device 102 or a single multi-functional processor or controller.

The processor 118 is operatively coupled to the aforementioned input output module 104, the audio module 110 and the cameras 106, 108.

The processor 118 is further coupled to a memory module 120. The memory module 120 may encompass one or more storage media and generally provide a place to store computer code (e.g., software and/or firmware). By way of example, the memory module 120 may include various tangible computer-readable storage media including Read-Only Memory (ROM) and/or Random-Access Memory (RAM). As is well known in the art, ROM acts to transfer data and instructions uni-directionally to the processor 118, and RAM is used typically to transfer data and instructions in a bi-directional manner.

Memory module 120 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to the processor 118. Information may also reside on one or more removable storage media loaded into or installed in the tablet device 102 when needed. By way of example, any of a number of suitable memory cards (e.g., SD cards) may be loaded into the tablet device 102 on a temporary or permanent basis (using one or more of the set of additional ports 116, as an example).

The memory module 120 may store inter alia a series of computer-readable instructions, which instructions when executed cause the processor 118 (as well as other components of the tablet device 102) to execute the various operations described herein.

In various particular embodiments, the tablet device 102 may additionally comprise a wireless communication module 122 and a sensor module 124, both operably connected to the processor 118 to facilitate various functions of tablet device 102.

Wireless communication module 122 can be designed to operate over one or more wireless networks, for example, a wireless PAN (WPAN) (such as, for example, a BLUETOOTH WPAN, an infrared PAN), a WI-FI network (such as, for example, an 802.11a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network). Additionally, wireless communication module 122 may include hosting protocols such that the tablet device 102 may be configured as a base station for other wireless devices.

The sensor module 124 may include one or more sensor devices to provide additional input and facilitate multiple functionalities of the tablet device 102. Some examples of implementations of the sensor module 124 can include one or more: an accelerometer, an ambient temperature measurement device, a device for measuring the force of gravity, a gyroscope, a device for measuring ambient light, a device for measuring acceleration force, a device for measuring ambient geomagnetic field, a device for measuring a degree of rotation, a device for measuring ambient air pressure, a device for measuring relative ambient humidity, a device for measuring device orientation, a device for measuring temperature of the device, etc. It is noted that some of these devices can be implemented in hardware, software or a combination of the two.

There is also provided a power source module 126 for providing power to one or more components of the tablet device 102. In some embodiments, the power source module 126 can be implemented as rechargeable lithium-ion battery. However, other types of rechargeable (or non-rechargeable) batteries can be used. Naturally, in other embodiments in addition or as an alternative to using batteries, the power source module 126 can be implemented as main power supplier connector configured to couple the tablet device 102 to the main power source, such as standard AC power cable and plug.

In various embodiments of the present technology, various components of tablet device 102 may be operably connected together by one or more buses (including hardware and/or software), the buses not being separately numbered. As an example and not by way of limitation, the one or more buses may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, a Universal Asynchronous Receiver/Transmitter (UART) interface, a Inter-Integrated Circuit (I²C) bus, a Serial Peripheral Interface (SPI) bus, a Secure Digital (SD) memory interface, a MultiMediaCard (MMC) memory interface, a Memory Stick (MS) memory interface, a Secure Digital Input Output (SDIO) interface, a Multi-channel Buffered Serial Port (McBSP) bus, a Universal Serial Bus (USB) bus, a General Purpose Memory Controller (GPMC) bus, a SDRAM Controller (SDRC) bus, a General Purpose Input/Output (GPIO) bus, a Separate Video (S-Video) bus, a Display Serial Interface (DSI) bus, an Advanced Microcontroller Bus Architecture (AMBA) bus, or another suitable bus or a combination of two or more of these.

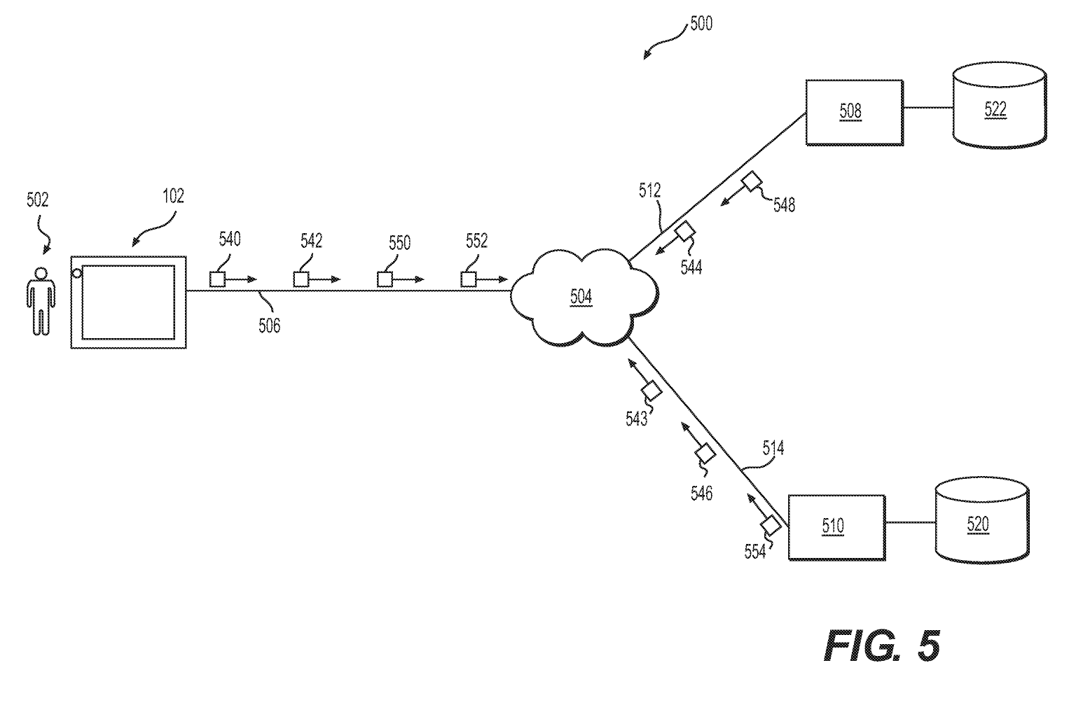

Referring now to FIG. 5, there is shown a schematic diagram of a system 500 being suitable for implementing non-limiting embodiments of the present technology. It is to be expressly understood that the system 500 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 500 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 500 may provide in certain instances simple implementations of the present technology, and that where such is the case they have been presented in this manner as an aid to understanding. As persons skilled in the art would understand, various implementations of the present technology may be of a greater complexity.

The system 500 comprises the aforementioned tablet device 102. The tablet device 102 is typically associated with a user 502. It should be noted that the fact that the tablet device 102 is associated with the user 502 does not need to suggest or imply any mode of operation, such as a need to log in, a need to be registered or the like.

The tablet device 102 comprises hardware and software and/or firmware (or a combination thereof) for executing various applications (such as a browser application, a mapping application and the like). One of the applications executed by the tablet device 102 allows the tablet device to access an application download service (to be described below).

The tablet device 102 is coupled to a communication network 504 via a communication link 506. In some non-limiting embodiments of the present technology, the communication network 504 can be implemented as the internet. In other embodiments of the present technology, the communication network 504 can be implemented differently, such as any wide-area communication network, local-area communication network, a private communication network and the like.

How the communication link 506 is implemented is not particularly limited and will depend on how the wireless communication module 122 of the tablet device 102 is implemented. Merely as an example and not as a limitation, the communication link 506 can be implemented as a wide-area wireless communication link (such as but not limited to, a 3G communication network link, a 4G communication network link), a local-area wireless communication link (such as but not limited to a Wireless Fidelity, or WiFi® for short, Bluetooth® and the like). Naturally, other types oft the communication links 506 are possible.

Also coupled to the communication network are an application repository 508 and an application server 510, together referred to as servers 508, 510. The servers 508, 510 can each be implemented as a conventional computer server. In an example of an embodiment of the present technology, each of the servers 508, 510 can be implemented as a Dell™ PowerEdge™ Server running the Microsoft™ Windows Server™ operating system. It is contemplated that the servers 508, 510 can be implemented in any other suitable hardware and/or software and/or firmware or a combination thereof. Naturally, the application repository 508 can be implemented differently from the application server 510.

In the depicted non-limiting embodiment of present technology, each of the servers 508, 510 is a single server. In alternative non-limiting embodiments of the present technology, the functionality of each of the servers 508, 510 may be distributed and may be implemented via respective multiple servers. In alternative non-limiting embodiments of the present technology, the functionality of the servers 508, 510 may be combined in a single server.

The implementation of the servers 508, 510 is well known to a person skilled in the art of the present technology. However, briefly speaking, the servers 508, 510 comprise a communication interface (not depicted) structured and configured to communicate with various entities (such as the tablet device 102, for example and/or each other) via the communication network 504. Each of the servers 508, 510 further comprises at least one computer processor (not depicted) operationally connected with the communication interface and structured and configured to execute various processes to be described herein.

The application repository 508 can be operated by and/or be under control and/or under management of an entity that either manufacturers and/or distributes the tablet device 102. As a non-limiting example, where the tablet device 102 is manufactured (directly or through sub-contractors) and/or distributed (directly or through resellers) by YANDEX corporation of Lev Tolstoy st. 16, Moscow, 119021, Russia, the application repository 508 can be managed and operated (directly or indirectly) by Yandex corporation.

The application server 510 can be operated by and/or be under control and/or under management of the entity that either manufacturers and/or distributes the tablet device 102. Alternatively, the application server 510 can be operated by and/or be under control and/or under management of an entity different from the entity that either manufacturers and/or distributes the tablet device 102. As a non-limiting example, where the tablet device 102 is manufactured (directly or through sub-contractors) and/or distributed (directly or through resellers) by YANDEX corporation of Lev Tolstoy st. 16, Moscow, 119021, Russia, the application server 510 can be managed and operated (directly or indirectly) by Yandex corporation. In some embodiments of the present technology, the application server 510 can be the same server that performs web searches (such as web searches available at www.yandex.com) for users, such as the user 502.

The application repository 508 is coupled to the communication network 504 via a communication link 512. The application server 510 is coupled to the communication network 504 via a communication link 514. How the communication links 512, 514 are implemented is not particularly limited and will depend on how the servers 508, 510 are implemented. It is contemplated that the examples of implementations of the communication link 506 provided above could be applied to the communication links 512, 514.

Naturally, in alternative embodiments of the present technology, the communication links 512, 514 can be implemented as wired connection, such as Ethernet based connection, fiber optical based connection and the like).

Also, even though not depicted in FIG. 5, the application repository 508 and the application server 510 can be interconnected by a direct link or a communication network that is separate from the communication network 504.

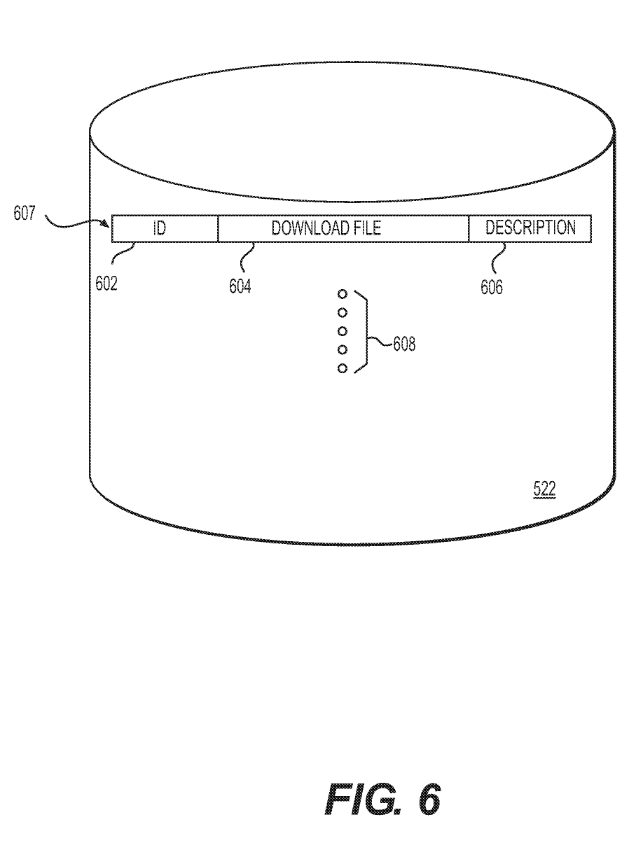

The application repository 508 is coupled to or otherwise has access to an application storage 522. The application storage 522 is configured to store one or more applications available for download from the application repository 508. A reference to FIG. 6 will now be made, which depicts a schematic representation of information maintained by the application storage 522, implemented in accordance with non-limiting embodiments of the present technology.

The application storage 522 maintains, for each available application, a record 607, which record 607 includes: an application identifier 602, a download file 604 (also referred to sometimes here as a “distributive file”) and a description 606. The application identifier 602 is used to uniquely identify the application the record 607 is associated with. The download file 604 contains an executable file or a link thereto, which executable file can cause installation of the application on the tablet device 102. The description 606 contains a description of the application with which the record 607 is associated, such as some or all of: a title, a brief description, user feedback, and the like.

The application storage 522 maintains a number of such records similar to the record 607, jointly depicted at 608.

The application server 510 is coupled to or otherwise has access to a log database 520. The log database is configured to maintain information representative of users' downloading behaviour, such as users' downloading behavior in regard to downloading, installing and deleting applications available on the application repository 508.

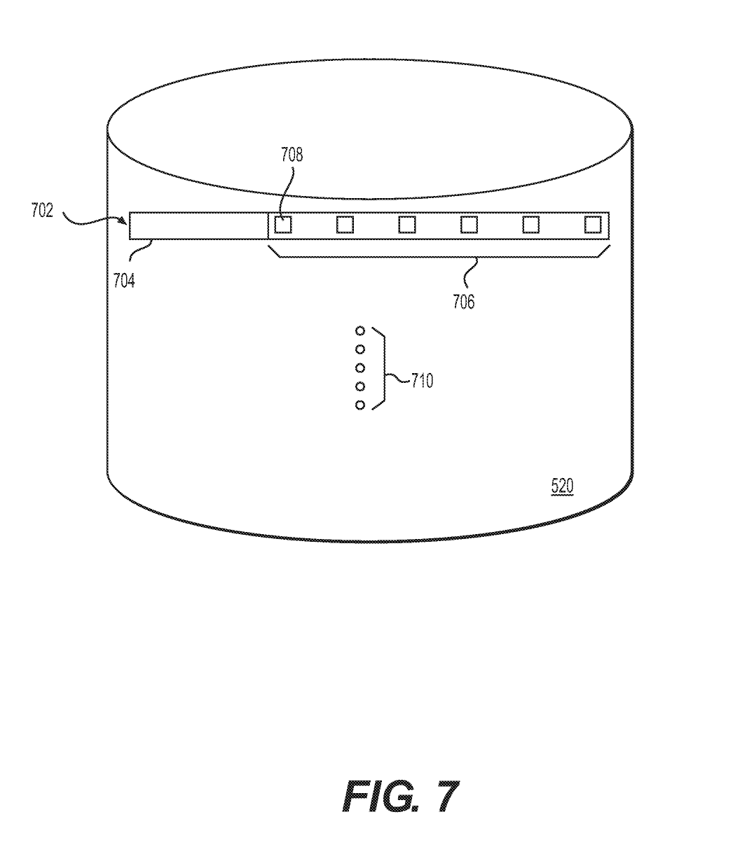

Reference to FIG. 7 will now be made, which depicts a schematic representation of information maintained by the log database 520, implemented in accordance with non-limiting embodiments of the present technology.

The log database 520 maintains, for each registered user (such as the user 502), a record 702, which record 702 includes: a user identifier 704 and an indication of a plurality of user events 706. The user identifier 704 is used to uniquely identify the user with which the record 702 is associated with. The user identifier 704 can include a user name, some other user credentials, a uniquely assigned alpha-numerical code and the like. In some embodiments of the present technology, the user identifier 704 information is provisioned by the user 502 during the user registration process with the application downloading service.

The plurality of user events 706 includes one or more past user events (only one numbered at 708) indicative of the user past interactions with the application repository 508. The user event 706 (as well as other events indication of which is maintained within the one or more past user events can include):
a list of applications previously downloaded by the user;
a list of applications currently installed on the electronic device;
a list of applications previously downloaded and later deleted by the user;
etc.

The log database 520 maintains a number of such records similar to the record 702, jointly depicted at 710.

In order to populate the log database 520, the application server 510 can receive information from several sources, such as the application repository 508, the tablet device 102 (either directly or via the application repository 508), as well as other electronic devices (either directly or via the application repository 508) associated with other users who subscribe to the application download service provided by the application repository 508.

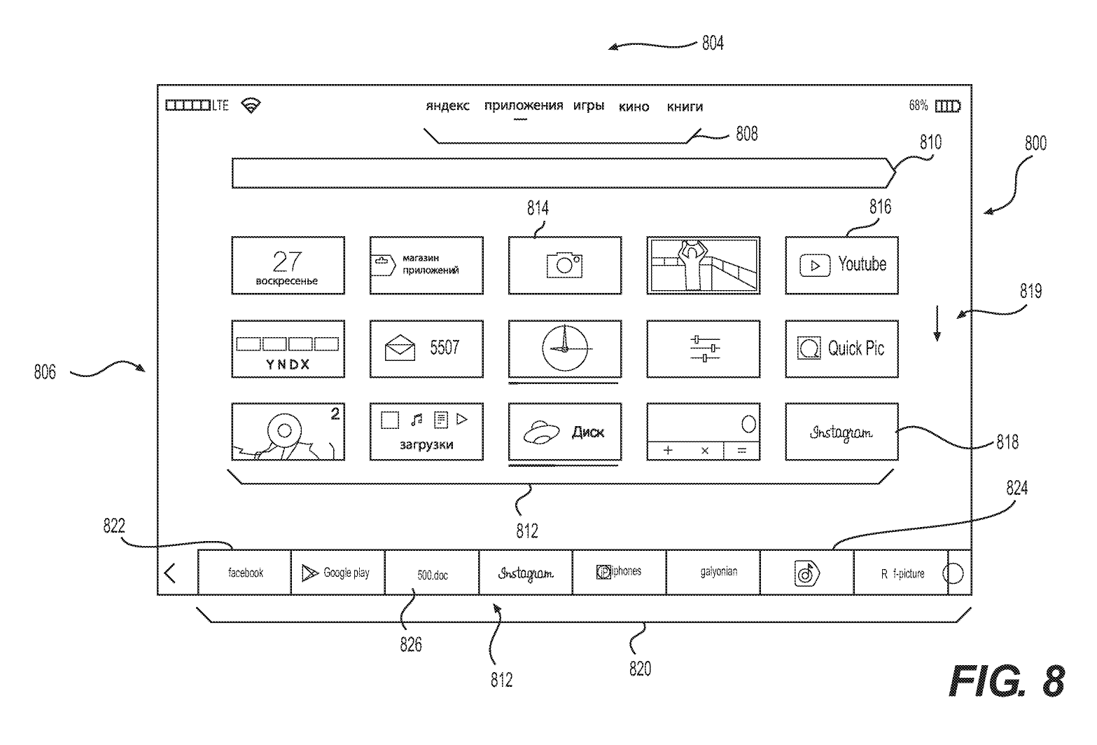

With reference to FIG. 8, there is depicted a screen shot 800, the screen shot 800 depicting an output of a first application 804, the first application 804 being executed on the tablet device 102 and displayed on the input output module 104. The first application 804 is a front end of an application download service, such as in this case, the application download service provided by the application repository 508. The first application 804 presents a first GUI 806. The first GUI 806 enables the user to interact with the application download service provided by the application repository 508.

Within the illustrated embodiment, the first GUI 806 presents a control panel 808. The control panel 808 presents the user several buttons to actuate the GUI 806 between different “screens” or “screen verticals”. In the illustrated embodiments, there are five buttons within the control panel 808—Yandex (illustrated in Russian as “ [symbol] ”), Applications (illustrated in Russian as “ [symbol] ”), Games (illustrated in Russian as “ [symbol] ”), Movies (illustrated in Russian as “ [symbol] ”), Books (illustrated in Russian as “ [symbol] ”) associated with a respective screen vertical. The currently active screen vertical, which in this case is the Applications screen, is associated with an active screen indicator (not separately numbered), which in this case is a small dash under the name of the screen vertical.

The GUI 806 further presents a plurality of icons 812. The plurality of icons 812 allows the user to select one or more applications that are available (i.e. that have been installed) on the tablet device 102. In the depicted embodiment, each of the plurality of icons 812 is presented as a rectangular graphical image, with an application logo, an application name or both. It should be expressly understood that the form factor of some or all of the plurality of icons 812 can be different (and they do not all need to be the same within the same screen of the GUI 806). For example, in alternative embodiments, the icons within the plurality of icons 812 can be presented as circular graphical images (or any other form factor of a graphical image), as textual links and the like. It is noted that the size of the graphical images can vary and/or can be adjusted by the user 502 by adjusting appropriate user settings.

Just to provide some examples, the plurality of icons 812 includes inter alia: a first icon 814 associated with a photo application, a second icon 816 associated with the YOUTUBE™ application, a third icon 818 associated with the INSTAGRAM™ application. Naturally, the plurality of icons 812 may contain more icons that can fit onto a single screen of the GUI 806. As such, in some embodiments there can be provided a scroll indicator 819. The scroll indicator 819 can be indicative of more icons available within the given screen vertical but not fitting within the given screen vertical, which icons can be scrolled to by user performing a predefined action (swiping vertically, actuating the scroll indicator 819 or any other suitable virtual or physical actuator of the input output module 104).

There is also provided a search bar 810. The search bar 810 can enable the user to input search queries, such as search queries for searching items stored on the memory module 120 (i.e. local items) and/or search the Internet (i.e. global items) and/or search items available from the application repository 508. Thus, the search bar 810 can be thought of a “multi-functional search bar” in a sense that it is configured to search locally within the memory module 120, files generally available in the Internet and files available for downloading from the application repository 508.

To complete the description of GUI 806, there is also provided a control elements tab 820. Generally speaking, the control elements tab 820 contains at least one element for controlling the tablet device 102. Within the various embodiments of the present technology, the control elements tab 820 can have a first tab element 822, the first tab element 822 for allowing the user to start the FACEBOOK application. The control elements tab 820 can have a second tab element 824 for allowing the user to start a media player. The control elements tab 820 can have a third tab element 826 for allowing the user to open a particular document, in this case a MICROSOFT™ WORD™ document 500.doc.

Put another way, the control element tab 820 can have one or more tab elements for allowing the user to control the tablet device 102 and/or the GUI 806: to execute one or more applications, to open one or more documents saved on the memory module 120, and the like. Thus, the control element tab 820 can be thought of a “multi-functional control element tab” in a sense that it is configured to trigger execution of applications and trigger opening of documents. In addition, in some embodiments, the control element tab 820 can also enable the user 502 to affect control of various other functions of the tablet device 102.

It should be noted that the description of the GUI 806 presented with reference to FIG. 8 is just one embodiment of one screen of the various screens potentially presentable to the user on the input output module 104.

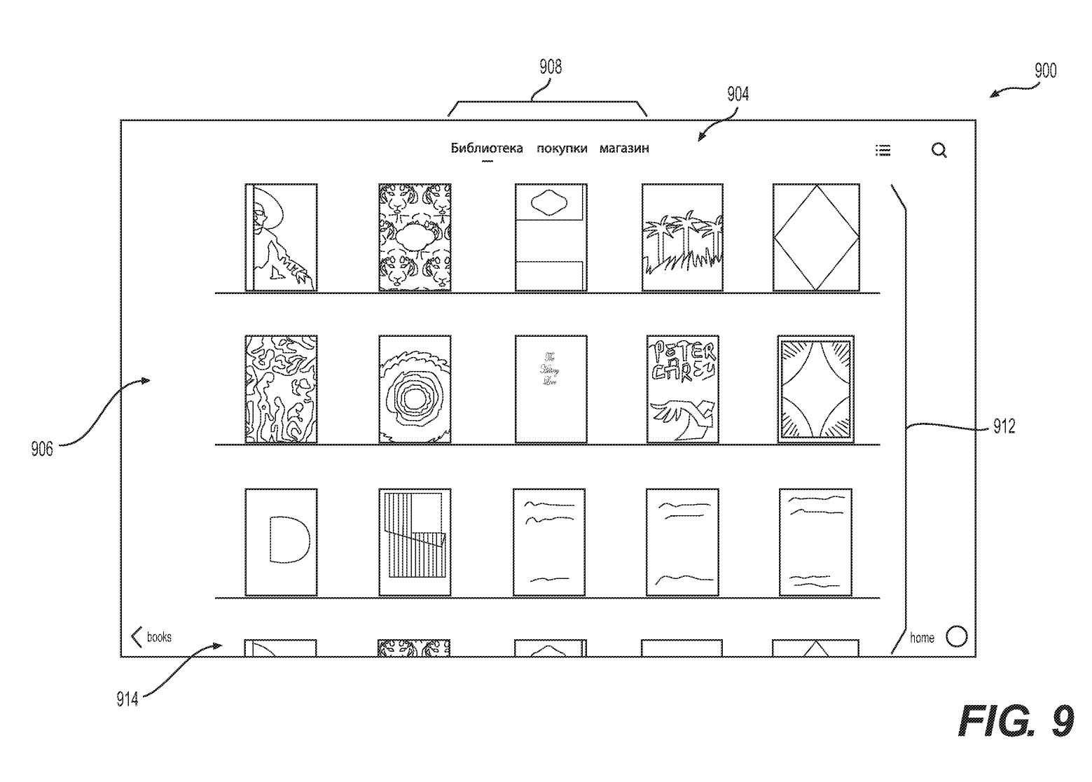

With reference to FIG. 9, there is depicted a screen shot 900, the screen shot 900 depicting an output of a second application 904, the second application 904 being executed on the tablet device 102 and displayed on the input output module 104. The second application 904 is a front end of a book reading service, which can also be provided by the application repository 508. The second application 904 presents a second GUI 906. The second GUI 906 enables the user to interact with the book reading service provided by the application repository 508.

Within the illustrated embodiment, the second GUI 906 presents a control panel 908. The control panel 908 presents the user several buttons to actuate the GUI 906 between different “screens” or “screen verticals”, which the illustrated embodiments, there are three buttons within the control panel 908—Books (illustrated in Russian as “ [symbol] ”) for books that have been downloaded to the tablet device 102, Purchased (illustrated in Russian as “ [symbol] ”) for purchased books using the tablet device 102 and On-line Store (illustrated in Russian as “ [symbol] ”) for connecting to the book reading service provided by the application repository 508. The currently active screen vertical, which in this case is the Books screen, is associated with an active screen indicator (not separately numbered), which in this case is a small dash under the name of the screen vertical.

It is noted that even though the control panel 908 is shown as replacing the control panel 808, in alternative embodiments, the control panel 908 can be shown as a subset (or a “slave”) to the control panel 808.

The GUI 906 further presents a plurality of icons 912. The plurality of icons 912 allows the user to select one or more books that are available (i.e. that have been installed) on the tablet device 102. In the depicted embodiment, each of the plurality of icons 912 is presented as a rectangular graphical image, with the cover image of the associated book. It should be expressly understood that the form factor of some or all of the plurality of icons 912 can be different (and they do not all need to be the same within the same screen of the GUI 906). For example, in alternative embodiments, the icons within the plurality of icons 912 can be presented as circular graphical images, as textual links and the like.

It is noted that in the illustration of FIG. 9, the GUI 906 does not contain a control element tab similar to the control elements tab 820 of FIG. 8. Within the illustration of FIG. 9, the control element tab 820 has been “hidden” from the view. This can be done, for example, after a pre-defined period of time of user not using the control element tab 820. For example, the user may have selected the Books application and desires to browse the available books and/or to read the particular book. In order to provide the user with the convenient user experience and present the content of the Books application or the books being read in the entirety of the input output module 104, the processor 118 can cause to the control element tab 820 to be hidden after certain pre-defined period of time. The user 502 can cause the control element tab 820 to be shown again, for example, by pressing in a lower-most area (not numbered) of the input output module 104, by actuating a physical button of the input output module 104 or the like.

Also, it is noted that the GUI 906 does not have a scroll indicator similar to the scroll indicator 819. However, the GUI 906 has a partial view 914 of additional books available from the book reading application. The partial view 914 can be used as a signal to the user that a scroll function is available, in lieu or in addition to the scroll indicator 819 used within the embodiment depicted in FIG. 8.

Also, it is noted that the GUI 906 does not have a search bar similar to the search bar 810. The user 502 can “activate” the search bar on the GUI 906 by executing a pre-defined gesture, such as a long swipe from top down, a swipe from right hand corner towards the left side corner and the like.

In accordance to various non-limiting embodiments of the present technology, the application server 510 is configured to execute a routine to perform a method of downloading an application to the tablet device 102, the application being available for downloading to the tablet device. In some embodiments of the present technology, the application is downloadable from the application repository 508. In some other embodiments, the application can be an application downloadable from other source on the Internet (i.e. one or more resources connected to the communication network 504, such as developers' forums or other resources that store free or pay-for applications for download).

It is noted that in alternative embodiments, the functionality of the application repository 508 and the application server 510 can be executed in a single server and be implemented as separate routines executed by the single server, executed in parallel or in sequence.

Illustrative Scenario

The following scenario will be used for illustrating the various embodiments of the present technology. The user 502 may start typing (using the input output module 104, for example) the name of the application within the search bar 810 (see FIG. 8, as an example). As an illustration, let it be assumed that the user 502 is looking for an application “Angry birds Space Edition” and, as such the user 502 may start typing in the name of the application—i.e. “ANG” into the search bar 810.

It is noted that in some embodiments of the present technology, the user 502 is typing the search query not into a so-called application store front, but directly into the search bar 810, the search bar 810 being implemented as the multi-functional search bar of the embodiments of the present technology. In some embodiments of the present technology, the user 502 may indicate her or him desire to search for applications, by typing in a pre-defined search string, such as “APP:”. In other embodiments, there may be an additional search button provided, such as “search for APPs” in addition to the general search. In yet other embodiments, the user desire can be presumed by the location from where the user has initiated the search, such as from the Applications or Books screen vertical. In yet other embodiments, the routines described below can be performed when the user 502 performs all searches using the search bar 810.

Application Suggestion Determination Routine

The tablet device 102 acquires the input of the three first letters of the name of the application the user 502 is searching for. Naturally, three letters is an example only and embodiments of the present technology apply to any length of a portion of the search query.

The tablet device 102 can transmit the captured input to the application server 510 via the communication network 504, depicted as a first control message 540 in FIG. 5. It is noted that the first control message 540, in addition to the captured entry of the search terms, may also include a user identifier associated with the user 502 (which may be obtained from a cookie stores on the tablet device 102 and the like).

The application server 510 receives the first control message 540 and appreciates the user identifier and the captured input of the search query. Based on the user identifier, the application server 510 accesses the log database 520 and retrieves the record 702 associated with the user 502 (based on matching the retrieved user identifier with the information stored in the user identifier 704). The application server 510 then acquires the indication of a plurality of user events 706 associated with the user 502.

The application server 510 then sends a query to the application repository 508, the query including the received search term (in this case “ANG”), the query for any applications matching the received search query. This query sending process is depicted as a second control message 542. In some embodiments of the present technology, in addition to querying the application repository 508, the application server 510 can execute a general search of the one or more resources available on the Internet and potentially storing applications available for downloading that are responsive to the user query. In some embodiments, the search can be done using an inverted index or any other suitable method known in the area of search engines and searching of the Internet.

The application repository 508 receives the second control message 542 and acquires the search query for matching applications. The application repository 508 performs a search and generates a list of all applications that match the search query and transmits an indication thereof to the application server 510, this being depicted as a third control message 543.

Let's assume that the list of matching applications includes four applications:
Angry Birds
Angry Birds Christmas Edition
Angry Birds Space Edition
ANG News

The application server 510 receives the third control message 543 and retrieves the list of matching applications available from the application repository 508.

The application server 510 can then augment the list of matching applications with applications located in the general search. This augmenting can include: removing duplicates and adding those of the applications found in the general search, but not received from the application repository 508.

The application server 510 can then analyze the received list of matching applications. In some embodiments, the step of analyzing is performed using the information retrieved from the plurality of user events 706 associated with the user 502. It should be recalled that the plurality of user events 706 associated with the user 502 can include one or more of:
a list of applications previously downloaded by the user 502;
a list of applications currently installed on the tablet device 102;
a list of applications previously downloaded and later deleted by the user 502;
etc.

The application server 510 can first execute a pruning routine. For example, the application server 510 can remove from the list of matching applications all the applications that match the list of applications previously downloaded by the user 502. Additionally or alternatively, the application server 510 can remove from the list of matching applications all the applications that match the list of applications currently installed on the tablet device 102. Additionally or alternatively, the application server 510 can remove from the list of matching applications all the applications that match the list of applications previously downloaded and later deleted by the user 502.

Let's assume that the user 502 already has installed, on the tablet device 102, the application Angry birds. As such, the application server 510 creates a pruned list of matching applications that includes:
Angry Birds Christmas Edition
Angry Birds Space Edition
ANG News

The application server 510 can further analyze the pruned list of matching applications. The application server 510 can conduct this analysis can also be performed using the information retrieved from the plurality of user events 706 associated with the user 502.

For example, the application server 510 can deduct, based for example, on the list of already installed applications, one or more applications from the pruned list of matching applications that the user 502 is looking for. For example, in the instant examples where the user 502 searched for “ANG” and based on the fact that the user already has Angry Birds application installed on the tablet device 102, the application server 510 may deduct that the two or more applications from the pruned list of matching application that the user 502 is looking for are applications Angry Birds Christmas Edition and Angry Birds Space Edition. In alternative embodiments, the decision can be made based on the fact that, in this example of Angry Birds application and ANG News application, the user has absolutely or proportionally more game applications than news applications installed on the tablet device 102.

On the other hand, in some embodiments of the present technology, the application server 510 may determine that either because the user 502 has the same number of news applications as the number of Angry Birds series of applications installed or because the information available is not sufficient to render a decision, the application may await further input from the user 502, as it is available from the tablet device 102. In alternative embodiments, the application server 510 may solicit further input from the user 502, by means of a fourth control message 546.

Meanwhile, the user 502 may continue typing in the user search query (for example, the user may have typed in an additional “R”, so the search query now reads “ANGR”) and the tablet device 102 generates a fifth control message 542 containing the updated search strings and transmits the fifth control message 542 to the application server 510.

The application server 510 then repeats the process of determining the best matched applications, as was described above with reference to the first control message 540.

Now, when the application server 510 receives the list of matched applications it no longer receives the ANG news application. As such the new list of matched applications contains:
Angry Birds
Angry Birds Christmas Edition
Angry Birds Space Edition

Much akin to what was described above, the application server 510 can also enrich the results received from the application repository 508 with the search results located in the general search.

Much akin to what was described above, the application server 510 determines that Angry Birds application is already installed on the tablet device 102 and, as such, determines that the pruned list of matched applications includes:
Angry Birds Christmas Edition
Angry Birds Space Edition

It should be noted that the exact logic used by the application server 510 to prune and/or to select one or more best matched applications from the list of matching application may vary in various embodiments of the present technology. Continuing with the example of “Angry Birds” following is provided for illustrative purposes:
The application server 510 may analyze the plurality of user events 706 and determine that the tablet device 102 already has installed application in the same category—in this example the application server 510 checks whether the user 502 has other games.
Alternatively or additionally, the application server 510 can check if the tablet device 102 has applications from the same developer installed thereupon.
Alternatively or additionally, the application server 510 can check if the tablet device 102 has other applications with a partially overlapping title installed thereon.
Alternatively or additionally, the application server 510 can check if the tablet device 102 has similar applications with a partially overlapping title installed thereon (based on the description 606, for example).
Alternatively or additionally, the application server 510 can check if the tablet device 102 has documents potentially associated with the application stored thereon (such as, Angry Birds hacks and Angry Birds guide, etc.)

The applications so-selected by the application server 510 can be thought of as “selected applications for downloading to the tablet device 102”.

Application Installation Procedure

Once the application server 510 determines two or more applications that are responsive to the user search query, the application server 510 executes an application installation procedure.

As part of the application installation procedure, the application server 510 causes the two or more applications selected as part of the application selecting routine to be downloaded to and installed on the tablet device 102. In some embodiments, the application server 510 causes the two or more applications selected as part of the application selecting routine to be downloaded to and installed on the tablet device 102 without the user 502 having to provide express instruction to have the applications downloaded and/or installed.

The application server 510 then causes the application repository 508 to generates a sixth command message 548, the sixth command message 548 containing respective distributive files associated with the two or more applications. The application repository 508 then transmits the sixth command message 548 to the tablet device 102 (either directly or via the application server 510). In some embodiments, the sixth command message 548 contains Android Application Package (APK) files.

In those embodiments, where the one or more of the selected applications for downloading to the tablet device 102 includes an application from a source other than the application repository 508, the application server 510 can cause the source other than the application repository 508 to transmit a command message similar to the command message 548.

The tablet device 102 receives the sixth command message 548 and retrieves the respective APK files therefrom. The device receives the application APK files and starts installing the application to the memory module 120 using the APK files. As an alternative, the application repository 508 or the other source, as the case may be, may load preinstalled version of the application (without the distributive).

Once the tablet device 102 installs the two or more applications, the tablet device 102 places the two or more applications into a tracking routine. As part of the tracking routine, the tablet device 102 monitors user interactions with the two or more applications that have been installed on the tablet device 102 from the selected applications for downloading to the tablet device 102.

In some embodiments of the present technology, the tablet device 102 monitors user interactions with the two or more applications for a pre-determined period of time, such as one day, 2 days, 5 days, a week and the like. The type of the user interaction is not particularly limited, but can include user starting the two or more applications, the user moving the two or more applications into a folder and the like.

In some additional embodiments of the present technology, the user interaction can be a payment for the one or more of the selected applications for downloading to the tablet device 102. It should be recalled that in some embodiments, the one or more selected applications for downloading to the tablet device 102 can be downloaded without obtaining an express user indication to download such the application. Within some of these embodiments, when the user 502 first launches the one or more of the selected applications for downloading to the tablet device 102, the tablet device 102 can solicit a payment from the user 502 and to transmit the payment indication to the application server 510. The payment processing can be executed in a conventional way (i.e. using a credit card or the like). Within these embodiments, the indication of the payment can be taken as the indication of the user interaction with the one or more of the selected applications for downloading to the tablet device 102.

In some additional embodiments of the present technology, the user interaction can be a selection of the preferences for the one or more of the selected applications that have been downloaded onto the tablet device 102. Within some of the embodiments of the present technology, when the user 502 first launches the one or more of the selected applications that have been downloaded onto the tablet device 102, the tablet device 102 can solicit a user selection of one or more of the preferences (such as access privileges and the like). The selection of the preferences can be executed in a conventional way (i.e. using a selection menu, a drop down menu, by presenting a series of preference questions or the like). Within these embodiments, the selection of the preferences can be taken as the indication of the user interaction with the one or more of the selected applications for downloading to the tablet device 102.

In some embodiments, if the tablet device 102 detects a user interaction, it sends a seventh command message 550 to the application server 510, the seventh command message 550 containing a confirmation that the user 502 has used the respective two or more applications. The application server 510 can use the information contained in the seventh command message 550 as an indication that the logic applied to the selection of the two or more applications matching the search query was correctly used.

If the user 502 does not interact with the respective one of the two or more applications, the tablet device 102 generates an eighth command signal 552 and transmits the eighth command signal 552 to the application server 510. The application server 510 receives the eighth command signal 552 and appreciates that the user 502 has not used the respective one of the two or more applications. This may be due to the fact that the application server 510 has incorrectly identified the two or more applications or that the user 502 was not actually interested in using the two or more applications.

The application server 510 can generate a ninth command signal 554, the ninth command signal 554 containing a trigger configured to cause the tablet device 102 to delete the two or more applications that has not been used by the user. In some embodiments, the trigger configured to cause the tablet device 102 to delete the two or more applications that has not been used by the user without receiving an express instruction from the user.

In some embodiments, in addition to the information extracted from the plurality of user events 706, the application server 510 can use additional information to select from the pruned list of matching applications. For example, the application server 510 can request from the tablet device 102 an indication of free amount of memory available on the memory module 120. Upon receipt of the indication of the free amount of memory available, and if the currently available memory space is not sufficient to store one or more of the one or more selected application, the application server 510 can select a subset of the one or more selected applications and send the subset of the one or more selected applications to the tablet device 102. The selection of the subset of the one or more selected applications can also be executed on the basis of information contained in the plurality of user events 706.

In some alternative embodiments, the application server 510 can use additional information for selecting subset of the one or more selected applications based on additional information about the tablet device 102 and/or the respective of the applications. Some examples of additional information about the tablet device 102 includes: screen resolution, graphic card parameters and the like. Some examples of additional information about the application includes: whether the application is better used on tablet devices 102 or smartphones, whether the application is better used in one orientation mode than the other (landscape vs portrait) and the like.

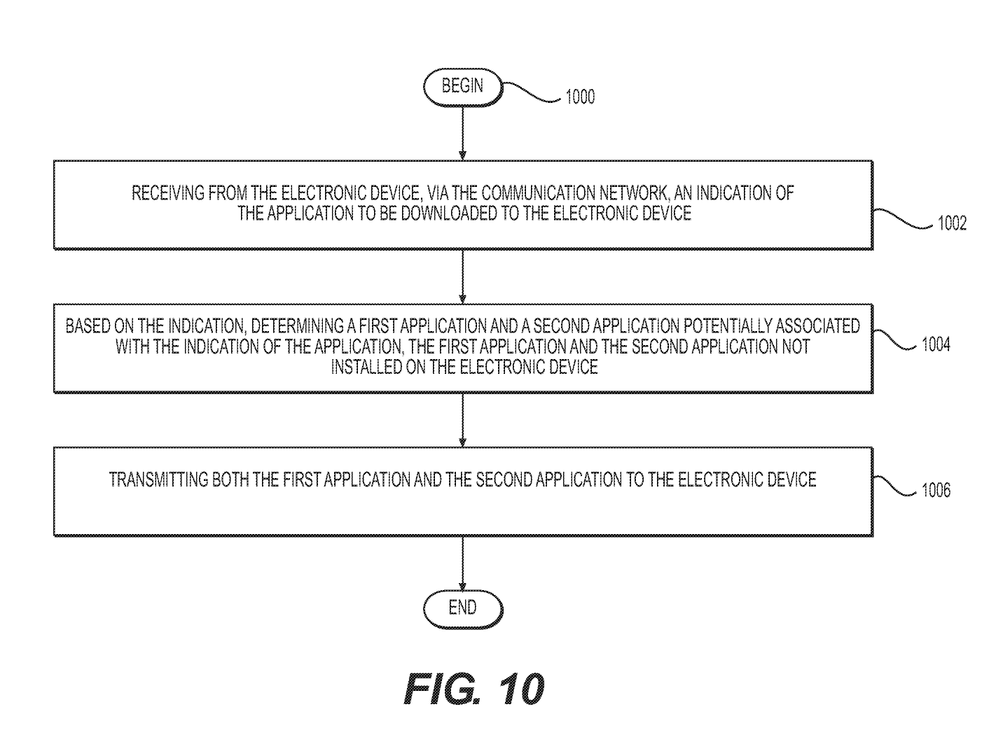

Given the architecture described above, the application server 510 is configured to execute a method of downloading an application to the tablet device 102 associated with the user 502. With reference to FIG. 10, there is depicted a flow chart of a method 1000, the method 1000 being executed in accordance with non-limiting embodiments of the present technology. The application server 510 has access to computer executable instructions stored on its internal memory (not depicted).

Step 1002—receiving from the electronic device, via the communication network, an indication of the application to be downloaded to the electronic device

The method 1000 starts at step 1002, where the application server 510 receives from the tablet device 102, via the communication network 504, an indication of the application to be downloaded to the tablet device 102.

Step 1004—based on the indication, determining a first application and a second application potentially associated with the indication of the application, the first application and the second application not having been installed on the electronic device

Next, at step 1004, the application server 510, based on the indication, determines a first application and a second application potentially associated with the indication of the application, the first application and the second application not having been installed on the tablet device 102.

In some implementations of the present technology, as part of step 1004, the method 1000 further comprises receiving an indication of plurality of user events. Within some of these implementations, the step of determining is based at least in part on the indication of plurality of user events.

It will be recalled that the indication of the plurality of user events can be received from the log database 520.

In some implementations of the present technology, the step of determining further comprises determining a third application potentially associated with the indication of the application. Within these implementations, the method 100 can further comprise, prior to the step of transmitting: selecting the first application and the second application from the first application, the second application and the third application to be transmitted to the electronic device, the step of selecting being based at least in part on the indication of plurality of user events.

In some implementations of the present technology, the method 1000 further comprises receiving an indication of at least one parameter of the tablet device 102 and the step of selecting can be further based at least in part on the at least one parameter of the tablet device 102. It should be recalled that some examples of at least one parameter of the tablet device 102 include: screen resolution, graphic card parameters and the like.

In other words, the step of selecting can be based on some or all of: (i) an indication received from the user 502 based on an entry of the user 502 and (ii) an indication that is not entered by the user 502. The indication that is not entered by the user 502 can be generated by the tablet device 102 (for example, an indication of the screen resolution) or can be retrieved from another source (such as, information maintained within the plurality of user events 706).

In some implementations of the present technology, the indication of plurality of user events comprises at least one of:
a list of applications previously downloaded by the user;
a list of applications currently installed on the electronic device;
a list of applications previously downloaded and later deleted by the user.

In some embodiments of the present technology, the indication of the application to be downloaded to the tablet device 102 comprises a portion of a title of the application entered by the user into the tablet device 102. The portion of the title can be entered using the search bar 810. It will be recalled that the search bar 810 can be implemented as the multi-functional search bar.

In some embodiments of the present technology, the step of determining a first application and a second application further comprises receiving an indication of at least the first application and the second application from the application repository 508, the receiving being executed in response to: (a) transmitting the indication of the application to be downloaded to the tablet device 102 to the application repository 508; (b) application repository 508 generating the indication of the first application and the second application based on a respective title of the first application and the second application matching the indication of the application to be downloaded to the tablet device 102.

In some embodiments of the present technology, the step of determining a first application and a second application further comprises receiving an indication of at least a portion of the first application and the second application from a resource other than the application repository 508, the resource being accessible via the communication network 504, the receiving being executed in response to: performing a general web search and locating the resource other than the application repository 508 that hosts at least the portion of application and the second application.

Step 1006—transmitting both the first application and the second application to the electronic device

Next, at step 1006, the application server 510 transmits both the first application and the second application to the tablet device 102.

Within some embodiments of the present technology, the step of transmitting 1006 is executed without receiving an express user confirmation of the user desire to have the transmitting executed.

Within some embodiments of the present technology, the step of transmitting both the first application and the second application to the tablet device 102 comprises transmitting a first execution file associated with the first application and a second execution file associated with the second application, the first execution file configured to cause the tablet device 102 to install the first application and the second execution file configured to cause the tablet device 102 to install the second application.

Within some embodiments of the present technology, the first execution file and the second execution file can cause the respective installation of the first application and the second application without receiving an express confirmation from the user.

In some implementations of the method 1000, the method 1000 further comprises receiving, from the tablet device 102, a first usage indicator associated with the first application and a second usage indicator associated with the second application, the respective first usage indicator and the second usage indicator having been generated by the tablet device 102 by monitoring if the user 502 has interacted with the respective first application and the second application.

In some implementations of present technology, the monitoring is executed within a pre-determined period of time from the time the step of transmitting is executed.

In some implementations of present technology, responsive to one of the first usage indicator and the second usage indicator being indicative of non-interaction with the respective one of the first application and the second application, the method 1000 further comprises: transmitting to the tablet device 102 a deletion trigger, the deletion trigger for causing the tablet device 102 to delete the respective one of the first application and the second application.

In some implementations of present technology, a respective one of the first usage indicator associated with the first application and the second usage indicator associated with the second application has been generated in response to the user 502 first launching the respective one of the first usage indicator associated with the first application and the second usage indicator associated with the second application.

In some implementations of present technology, a respective one of the first usage indicator associated with the first application and the second usage indicator associated with the second application has been generated in response to the user 502: (a) first launching the at least one of the first application and the second application using the tablet device 102; (b) confirming payment information.

In some implementations of present technology, a respective one of the first usage indicator associated with the first application and the second usage indicator associated with the second application has been generated in response to the user 502: (a) first launching the at least one of the first application and the second application using the tablet device 102; (b) confirming feature selection information.

It is noted that the above examples have been described with the application server 510 determining two or more applications for downloading to the tablet device 102 and causing such two or more applications to be downloaded to the tablet device 102. In some of the examples provided, the two or more applications are downloaded and installed on the tablet device 102 without receiving an express confirmation of the user desire to have the two or more applications installed.

As such in alternative non-limiting embodiments of the present technology, the method 1000 can be executed as containing the steps of: receiving from the electronic device, via the communication network, an indication of the application to be downloaded to the electronic device; based on the indication, determining a first application potentially associated with the indication of the application, the first application not having been installed on the electronic device; transmitting the first application and the second application to the electronic device, the transmitting being executed without receiving an express user confirmation of the user desire to have the transmitting executed.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

One skilled in the art will appreciate when the instant description refers to “receiving data” from a user that the electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of downloading an application to an electronic device associated with a user, the method being executed at a server, the server being connectable to the electronic device via a communication network, the method comprising:
receiving from the electronic device, via the communication network, an indication of the application to be downloaded to the electronic device;
based on the indication, determining a first application and a second application potentially associated with the indication of the application, the first application and the second application not having been installed on the electronic device, the determining including:
receiving an indication of plurality of user events,
determining a third application potentially associated with the indication of the application,
selecting the first application and the second application from the first application, the second application and the third application to be transmitted to the electronic device, and
the selecting being based at least in part on the indication of plurality of user events; and
transmitting both the first application and the second application to the electronic device.

2. The method of claim 1, wherein the transmitting is executed without receiving an express user confirmation of the user desire to have the transmitting executed.

3.-5. (canceled)

6. The method of claim 1, the method further comprises receiving an indication of at least one parameter of the electronic device and wherein the step of selecting is further based at least in part on the at least one parameter of the electronic device.

7. The method of claim 1, wherein the indication of plurality of user events comprises at least one of:
a list of applications previously downloaded by the user;
a list of applications currently installed on the electronic device;
a list of applications previously downloaded and later deleted by the user.

8. The method of claim 1, further comprising receiving, from the electronic device, a first usage indicator associated with the first application and a second usage indicator associated with the second application, the respective first usage indicator and the second usage indicator having been generated by the electronic device by monitoring if the user has interacted with the respective first application and the second application.

9. The method of claim 8, wherein the monitoring is executed within a pre-determined period of time from the transmitting.

10. The method of claim 8, wherein responsive to one of the first usage indicator and the second usage indicator being indicative of non-interaction with the respective one of the first application and the second application, the method further comprises:
transmitting to the electronic device a deletion trigger, the deletion trigger for causing the electronic device to delete the respective one of the first application and the second application.

11. The method of claim 8, wherein a respective one of the first usage indicator associated with the first application and the second usage indicator associated with the second application has been generated in response to the user first launching the respective one of the first usage indicator associated with the first application and the second usage indicator associated with the second application.

12. The method of claim 8, wherein a respective one of the first usage indicator associated with the first application and the second usage indicator associated with the second application has been generated in response to the user:
first launching the at least one of the first application and the second application using the electronic device;
confirming payment information.

13. The method of claim 8, wherein a respective one of the first usage indicator associated with the first application and the second usage indicator associated with the second application has been generated in response to the user:
first launching the at least one of the first application and the second application using the electronic device;
confirming feature selection information.

14. The method of claim 1, wherein the transmitting both the first application and the second application to the electronic device comprises transmitting a first execution file associated with the first application and a second execution file associated with the second application, the first execution file configured to cause the electronic device to install the first application and the second execution file configured to cause the electronic device to install the second application.

15. The method of claim 14, wherein the first execution file and the second execution file can cause the respective installation of the first application and the second application without receiving an express confirmation from the user.

16. The method of claim 1, wherein the indication of the application to be downloaded to the electronic device comprises a portion of a title of the application entered by the user into the electronic device.

17. The method of claim 16, wherein the portion of the title has been entered using a search bar.

18. The method of claim 17, wherein the search bar is a multi-functional search bar.

19. The method of claim 1, wherein the determining a first application and a second application further comprises receiving an indication of at least the first application and the second application from an application repository, the receiving being executed in response to:
transmitting the indication of the application to be downloaded to the electronic device to the application repository;
generating, by the application repository, the indication of the first application and the second application based on a respective title of the first application and the second application matching the indication of the application to be downloaded to the electronic device.

20. The method of claim 19, wherein the determining a first application and a second application further comprises receiving an indication of at least a portion of the first application and the second application from a resource other than the application repository, the resource being accessible via the communication network, the receiving being executed in response to:
performing a general web search and locating the resource other than the application repository that hosts at least the portion of the first application and the second application.

21. The method of claim 1, the method further comprises receiving a payment instruction associated with at least one of the first application and the second application from the electronic device, the payment instruction having been generated by the electronic device in response to the user:
first launching the at least one of the first application and the second application using the electronic device;
confirming payment information.

22. The method of claim 1, wherein the electronic device is a tablet device.

23. A server comprising:
a communication interface for a two-way communication with a an electronic device over a communication network,
a processor coupled to the communication interface, the processor configured to execute the method of claim 1.

24.-48. (canceled)
